(19) United States
(12) Patent Application Publication
(10) Pub. No.: US 2009/0097721 A1
(43) Pub. Date: Apr. 16, 2009

(54) METHOD OF IDENTIFYING FEATURES WITHIN A DATASET

(75) Inventors: Nicholas Geoffrey Kingsbury, Cambridge (GB); Ryan Alexander Anderson, Brunner (CA)

Correspondence Address: BROOKS KUSHMAN P.C., 1000 TOWN CENTER, TWENTY-SECOND FLOOR, SOUTHFIELD, MI, 48075, US

(73) Assignee: Cambridge University Technical Services Limited, Cambridgeshire (GB)

(21) Appl. No.: 11/722,009

(22) PCT Filed: Dec. 15, 2005
(86) PCT No.: PCT/GB05/04840

§ 371 Date: Feb. 22, 2008

(30) Foreign Application Priority Data
Dec. 17, 2004 (GB) 0427737.2

(51) Int. Cl. G06K 9/00

(52) U.S. Cl. 382/128

(57) ABSTRACT

A method of identifying features within a dataset such as an image comprises applying a multiscale transform such as a dual tree Complex Wavelet Transform to generate a plurality of scale-related transform levels each having a plurality of transform coefficients defining magnitude and phase; determining the phase difference between a first coefficient on one level, and a second coefficient on the same or a different level; and identifying the feature in dependence on the phase difference. Each quadrant of the phase difference, when plotted as an angle, is indicative of a different type of feature. The invention is equally applicable to the identification of two-dimensional features such as images, as well as to the identification of features within one-dimensional data streams such as audio.

The present invention relates to method of identifying features within a dataset, for example within an image, a moving image or a 1D dataset such as a medical ECG or EEG. It is expected to find application in (amongst other things) medical imaging including the identification of diseased tissue, face detection/face recognition, machine vision, the detection of features of interest within satellite photographs, in the searching for a specific image within a large database of images, as well as in voice recognition and other audio, medical and 1D applications.

The use of shape in general image comparison can be loosely divided into two categories: Shape Retrieval, which is a subset of image retrieval, and Object Recognition, which is more commonly seen in computer vision applications. Shape Retrieval algorithms typically gather general edge and area statistics of a given image region, quantify them in a feature space, and compare these statistics to other images to measure overall image similarity. Object recognition, by contrast, usually compares image attributes to known prototypes of a specific object.

A variety of different approaches are often used to identify features within an image, some of which are briefly described below:

WO0003347 makes uses of a compression method which looks at directional energy within the image in three directions. In the present applicant's view, this approach is unable to provide a consistent, adequate representation of the image.

WO0243004 uses quadrature-phase Gabor filters to detect specific features of shape. The method described uses even and odd Gabor filters and looks at features on an intra scale basis. The method described works on a pixel by pixel basis, and is therefore unsuitable for searching large databases as it is relatively computationally intensive.

DE4406020 again uses Gabor filters for image recognition.

U.S. Pat. No. 6,674,915 extracts global features from an image using co-occurrence and histogram statistics from a steerable pyramid decomposition.

U.S. Pat. No. 5,956,427 describes a method for determining the amount of orientation in an image. It uses Gabor filters to represent directional image components, and then uses the Discrete Fourier Transform to detect rotated versions of the image. It concentrates upon the recognition of rotated versions of oriented features, where spatial relationships are unimportant.

US2002057838 and EP1229486 both make use of Hough transforms. This approach assumes that simple geometric objects such as straight lines are present in images, and then searches for the most likely parameters for those objects, for example the angle and the location offset. The Hough transform is extremely computationally intensive and is inflexible for general image analysis.

U.S. Pat. No. 6,694,054 uses Fourier-Mellin Transforms for pattern recognition. Fourier Mellin Transforms provide invariance to rotation, scaling and translation, but are very computationally intensive since they work in the pixel domain.

U.S. Pat. No. 5,550,933 this uses the Flow Integration Transform to perform a one dimensional boundary comparison around the edge of a desired object. It is entirely pixel based, and does not use any image area information. This method is not expected to be particularly effective for comparisons between natural images.

US2004114781 uses Daubechies Transforms for human iris recognition. These transforms are real valued wavelets, and are not shift invariant, neither do they carry phase information.

http://braultp.free.fr/papiers/BraultMounier_SPIE01_recompil_lavr04.pdf “Automated, transformation invariant, shape recognition through wavelet multiresolution.” This paper uses regular wavelets and performs contour comparisons between the edges of two segmented objects at various scales. No phase information is used.

http://cnx.rice.edu/content/m11694/latest/—(Mowad and Chandrasekaran at Rice). A method of template matching which exploits the complex wavelet transform magnitudes, substituting these magnitudes for the real-valued results of a standard discrete wavelet transform. It is a simple, effective extension of the Jacob, Finkelstein, and Salesin method to introduce shift invariance.

http://bigwww.epfl.ch/publications/forster0302.pdf—(Forster, Blu & Unser at EPFL). Complex rotation-covariant wavelet transforms—a type of complex wavelet transform, in which the phase of each coefficient reflects the directionality of the image in the proximity of the coefficient, as opposed to rotations of the entire image. An advantage of this transform is that it is non-redundant; a disadvantage is that it is shift-variant.

http://www-sop.inria.fr/ariana/personnel/Andre.Jalobeanu/spie03.pdf—(Jalobeanu & Blanc-Feraud at NASA Ames and Zerubia at INRIA, France). Complex wavelets for image modelling.

According to the present invention there is provided a method of identifying features within a dataset, comprising:
(a) applying a multi-scale transform to the dataset to generate a plurality of scale-related transform levels each having a plurality of transform coefficients defining magnitude and phase;
(b) determining the phase difference between a first coefficient associated with a first location and a second coefficient associated with a second location; the second location being the same as or adjacent to the first location; and
(c) identifying a feature in dependence upon the phase difference.

The first and second coefficients may either be on a common level within the transform tree, or alternatively they may be on adjacent levels. It will be understood, of course, that where reference is made in the claims to “first” to “second” levels, those expressions are intended merely as labels. The “first” level may correspond to any level within the tree, for example level 3, and the “second” level may correspond to any adjacent level, for example level 4.

Where the first and second coefficients are at the same level within the tree, they may be adjacent to one another, in which case all that is required is to calculate the phase difference between them. If complex representations of the coefficients are being used, for example if the transform is a dual tree Complex Wavelet Transform, then a convenient way to determine the phase difference is simply to multiply one coefficient by the conjugate of the other.

Where a phase difference needs to be calculated between levels, some pre processing may need to be done to ensure the presence of equivalent coefficients at each level so that a meaningful phase difference or multiplication with the complex conjugate can be calculated. In a typical decimating scheme, each finer level within the tree may have twice as many sample points/coefficients as the previous level. Accordingly, in order to generate a suitable number of coefficients to match with a next finer level, the coefficients of the coarser level may be interpolated and upsampled for example by a factor of two. It is a further feature of the dual tree CWT that shifting a feature within the dataset will cause the coefficient phase angles of a given level to rotate exactly half as fast as those of the next finer level. To ensure comparability, therefore, the phases/phase angles of the coarser level may be multiplied by two (in radians) to ensure phase comparability with the phases of the next finer level.

It is not essential for the coefficients to be represented as to magnitude and phase in a complex manner. As will readily be understood, an alternative approach which is essentially mathematically equivalent is to make use of two phase-sensitive real filters, arranged in quadrature.

The method may be applied to the identification of a target within a target dataset, for example the identification of the target image within a larger candidate image. This is preferably carried out by determining magnitude and phase as described above across the entire extent of both the target and the candidate. These may be conveniently represented in complex form. The target is then positioned at a trial location within the candidate, and the respective coefficients are multiplied together, coefficient and corresponding conjugate. This provides a complex ‘measure of match’. The process is repeated for all possible trial target locations within the candidate, and the respective measures of match are used to determine whether, at each trial location, the target can be said to have been identified.

Because the measure of match may in some cases be sensitive to sampling offsets (for example where the actual position of the target falls part-way between two sampling points) a more robust measure may be an average of several measures of match taken over not only the sample location but also over small offsets of the sample location in each possible direction.

Although the invention has been described primarily in connection with 2D datasets such as images, it will also find applicability for use with a wide variety of 3D datasets (eg time-varying images) such as medical imaging data from CT or MRI scans. In 1D, applications include medical ECGs and EEGs, as well as audio data.

The invention further extends to a computer program comprising program code for executing the method as previously described.

The invention may be carried into practice in a number of ways and one specific embodiment will now be described, by way of example, with reference to the accompanying drawings, in which:

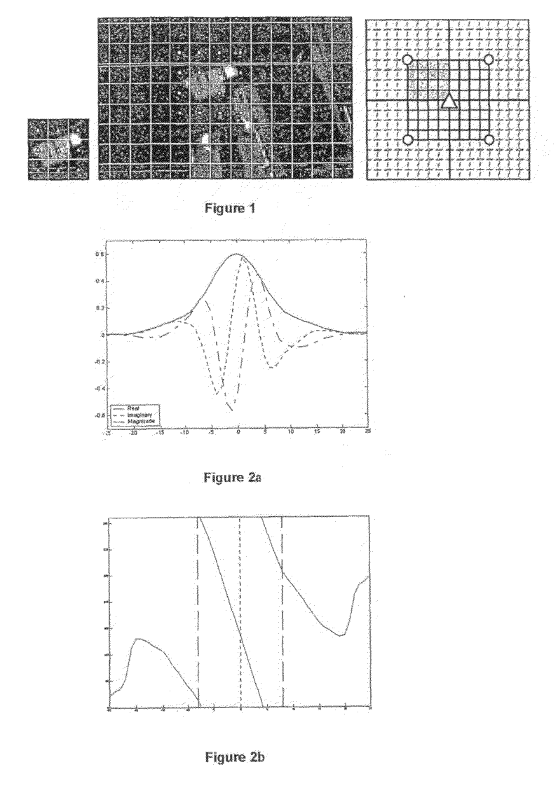

FIG. 1 shows the potential effect of a misalignment during template matching.

FIG. 2a shows the magnitude response of a decimated level 3 DT CWT coefficient, in the presence of a step edge at all possible offsets (along the x axis).

FIG. 2b shows the complex phase of the level 3 DT CWT coefficient under the same conditions;

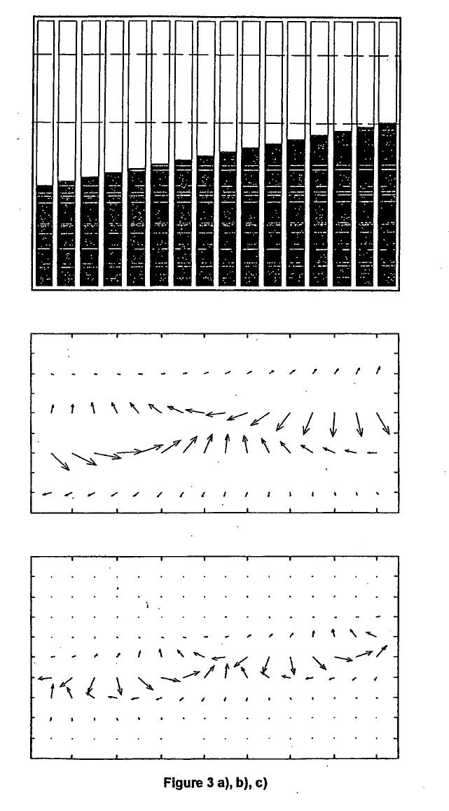

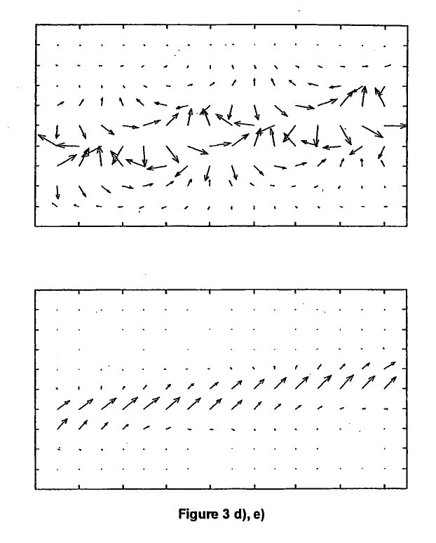

FIG. 3a shows all possible relationships a step edge may have to the nearest sampling point.

FIG. 3b shows the resulting level 4 DT CWT wavelet coefficients corresponding to the 16 shifted edges shown in FIG. 3a;

FIG. 3c shows the corresponding level 3 DT CWT coefficients;

FIG. 3d shows the level 4 coefficients of FIG. 3b, but upsampled and interpolated to level 3 resolution, and with their phase angles having been doubled. This ensures that the coefficients are now rotating at the same rate as the level 3 DT CWT wavelet coefficients in FIG. 3c.

FIG. 3e illustrates the interlevel product at level 3. This is obtained by multiplying the level 3 wavelet coefficients in FIG. 3c with the complex conjugate of the corresponding coefficients in FIG. 3d;

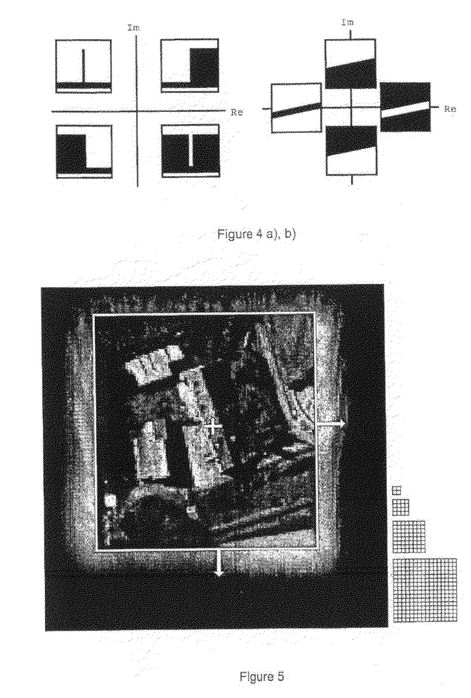

FIG. 4a illustrates schematically the relationship between complex phase and the presence of specific features in the one dimensional interlevel product;

FIG. 4b illustrates the corresponding relationships in the 15 degree sub-band of the two dimensional interlevel product; and

FIG. 5 shows an example of the calculation of the interlevel product average for a target image.

### 1. BACKGROUND

### Wavelets and Complex Wavelets

The wavelet transform has gained popularity in the signal processing community over the last 20 years, with a particular focus upon signal compression. Its ability to efficiently concentrate image energy into a form suitable for quantization has resulted in its adoption within several compression standards, including JPEG2000.

In general, the purpose of a wavelet transform is to segregate the energy of signals and images into compartments of space and frequency. This reorganisation is performed through the multiplication of an image with a finite-support, zero-mean mother wavelet that can be dilated and translated to vary the localization of energy in frequency and space, respectively.

The wavelet has been historically synonymous with compression. However, in the late 1980's a smaller subset of researchers began using wavelets as an analysis tool for seismic signals. And, indeed, the wavelet's ability to spatially localise frequency components has provided an excellent tool for various basic functions in signal analysis, such as anomaly detection. Higher level pattern recognition, however, requires a feature space that is more robust and comprehensive. A standard wavelet decomposition can produce such a space; the strengths of the wavelet in a pattern recognition feature space are a) its ability to characterize an object or texture at several resolutions, and b) its ability to capture an object's signature both in frequency and space. However, for object recognition feature spaces, the dyadic DWT also contains fundamental deficiencies that must be addressed:
1. Lack of Shift Invariance. The distribution of image energy between levels of DWT coefficients is highly variable and sensitive to small spatial shifts of the image prior to transform. This variance results from aliasing due to downsampling at each wavelet level. Accordingly, a DWT-based feature space for object recognition would contain object/texture classes that are unstable and difficult to cluster.
2. Lack of Directional Selectivity. As described above, a 2-dimensional DWT decomposition has the ability to characterise horizontal, vertical, and “diagonal” subbands within an image. In particular, this limited level of directional decomposition is inadequate for the discrimination of objects or textures that may possess subtle differences in their directional energy distribution.

One class of wavelet transform is specifically designed to address these short-comings: the Dual-Tree Complex Wavelet Transform, or “DT CWT”, as introduced in N. G. Kingsbury: “Image processing with complex wavelets”, Phil. Trans Royal Society London, 1999. The DT CWT seeks to create shift invariance by using two filters in parallel, each the Hilbert transform of the other, to analyze the input signal at each level. With this wavelet design, the transfer function through any given subband is invariant to input signal shifts. These two filters can be considered as imaginary and real components of a single complex filter that yields a complex coefficient output. The magnitude of this resulting complex coefficient only fluctuates slowly relative to shifts in the input signal. Additionally, the present applicants have now recognised that the phase of the complex coefficient varies in a consistent, linear relationship with the spatial offset of a local edge oriented in the same subband. It is this latter property of the DT CWT that we now seek to exploit, to uniquely represent an object using a minimal number of coefficients that consistently represent a potentially complex object.

### 2. INTRODUCING THE INTERLEVEL PRODUCT

We seek to blend the goals of both Shape Retrieval and of Objection Recognition by introducing a new decimated basis which is based upon the shift-invariance of the Dual-Tree Complex Wavelet Transform (DT CWT). This basis, which we name the InterLevel Product (ILP), possesses a dimensionality equal to the DT CWT. However, the phases of the ILP coefficients indicate the type of features present at each scale and subband orientation, and the ILP magnitudes are proportional to the magnitudes (importance) of these features at two adjacent scales. These coefficients exhibit strong invariance to shifts of the decimation grid, and therefore provide a rich, reliable representation of the original image at multiple scales.

With this new tool, we demonstrate multiscale measures that can simultaneously accelerate template-matching methods for 2-D object recognition and increase the information available to evaluate near-matches. Section 4, below, introduces the ILP, describes its relationship to semantic image content, and shows its ability to successfully match images at coarse scales.

### 3. CLASSIC MULTISCALE TEMPLATE MATCHING

Classic template matching with a normalised cross-correlation (NCC) is performed with the calculation below:

$$γ ( x , y ) = \frac{{\sum }_{α , β} [ ( S ( α - x , β - y ) - {\overline{S}}_{α , β} ] [ ( T ( α , β ) - \overline{T} ]}{\sqrt{{\sum }_{α , β} [ {( S ( α - x , β - y ) - {\overline{S}}_{α , β} ]}^{2} {\sum }_{α , β} [ {( T ( α , β ) - \overline{T} ]}^{2}}}$$

γ(x,y) is the correlation value between an N×M target image, T, and equivalently sized candidate regions, centred at (x,y) of a (typically) much larger X×Y search database image S. The location of the best match candidate is found at (x,y)=max_{(x,y)ε(X,Y)}γ(x,y), and γ(x,y) itself indicates the strength of the match, with γ(x,y)=1 indicating a perfect match.

The NCC method has several disadvantages of note. First, its computational complexity is high, due to the need for pixel-by-pixel comparison at each (x,y) offset of the candidate image. Several methods have been introduced that attempt to reduce these computations, such as normalization after matching in the Fourier domain. A second disadvantage of the NCC is that the correlation measure, γ(x,y), is a simple scalar value that does not provide significant insight into the nature by which the target T and candidate region I(x,y) differ.

Multiscale template matches have the potential to solve the two disadvantages highlighted above, by first matching coarse-level, decimated representations of the target and the search database. Decimation by l levels transforms an image from N×M pixels to N/2^{l}×M/2^{l} values; matching computation is therefore reduced by a factor of 16^{l}/c, where c is the dimensionality of the tensor at each decimated location. High-dimension tensors will limit the acceleration of the multiscale algorithm within a coarse scale search; however, if this high-dimensionality reduces false alarms at coarse scales, then the number of subsequent searches at finer scales is reduced. With the selection of an appropriately expandable tensor, an optimal point can be found in this tradeoff.

The largest difficulty with multiscale template matching is that, in the general case, a decimated representation of the target will be based upon a reference grid that is different from a search image. There is potential for misalignment of up to 75%, where the closest matching search coefficient for a given target coefficient is calculated from only 25% of the same pixel values. Turning to the example shown in FIG. 1, assume we perform a template match by first decimating an image by 3 levels, so that an 8×8 (2³×2³) patch of image is represented by a single coefficient (or tensor). In this scenario, the candidate image could be misaligned by up to 4 pixels vertically aizd 4 pixels horizontally. If the target (left) is represented by nine coarse-level coefficients, represented here by triangles, and is template-matched with a larger candidate database (middle), with decimated coefficients represented by circles, then the support areas of each coefficient can be vastly different. In this example, the central triangle coefficient in the target is calculated by no more than 25% of any of the four central circle coefficients in the candidate image, as illustrated on the right.

To compensate for this potential error, one could blur the original image prior to decimation in order to extend the overlap of image content into several coefficients; but then critical details, particularly edge information, will be lost. The Discrete Wavelet Transform (DWT) provides a good basis for preserving relevant edge information at a given decimation level; however, the DWT is highly shift-dependent, and will still therefore suffer from reference grid misalignment. We therefore consider the complex wavelet transform, specifically the Dual-Tree Complex Wavelet Transform, or DT CWT. The coefficients of the DT CWT accurately reflect local edge content; the magnitudes are relatively shift invariant, and phases change linearly with the offset of a local edge relative to the coefficient. The simplest way to use the DT CWT in a decimated template match is to search for the magnitudes of the coefficients. This method shows distinct advantages to regular DWT of the same resolution (with tensor dimensionality c=6 instead of c=3, however).

### 4. CALCULATION OF THE INTERLEVEL PRODUCT

DT CWT coefficient magnitudes are relatively shift-invariant, but they remain non-informative with regards to the actual structure of the underlying image. For instance, the representation of a ridge vs. a step edge is not readily apparent from a DT CWT coefficient magnitude. Such ambiguities increase the probability of false matches at coarse scales, and therefore increase our search time for a coarse-to-fine template match. We therefore look at the phase of a DT CWT coefficient to provide us with such information.

If one were to observe a 1-D level 4 DT CWT coefficient while a step edge was translated past it, its magnitude and phase behave as shown in FIGS. 2a and 2b.

Specifically, FIG. 2a shows the magnitude response of a decimated level 3 coefficient, in the presence of a step edge at all possible offsets (the x axis). The overall magnitude is calculated from real and imaginary components, as shown.

FIG. 2b shows the complex phase θ₃ of the level 3 coefficient (located at the central dotted line) under the same conditions. Note that when an edge occurs anywhere between the coefficient and its immediate neighbours (these neighbours being shown as the vertical dashed lines), the phase response is linear. This linearity may be used to infer the offset of the edge, relative to the coefficient location, at this scale. In this figure, the distance between the outer dotted lines represents twice the sampling interval.

Note that, in particular, the phase of the level 4 coefficient θ₄ changes linearly with the offset position of the edge, and rotates over the complex plane. This linear relationship disappears when the step edge is further than ¾ of the inter-coefficient distance, due to the small magnitudes of the coefficient response. Accordingly, θ₄ is only a reliable representation of the offset of the edge in the immediate vicinity of the coefficient, where the complex magnitude is large.

If the same step edge “wave” is also observable at level 3—i.e., it is a multiscale edge present in both scales—the child coefficients of the original level 4 wavelet will also undergo complete 360° rotation; however, the rotation will occur at twice the speed; or, in other words, the spatial rotation rate \dot{θ}₃=2\dot{θ}₄

The constancy of this ratio provides us with a coarse-level, shift-invariant feature for a structure; regardless of the distance of the edge relative to the nearest original level 3 coefficient location, this difference in phase, θ_{Δ}=2θ₄−θ₃, is relatively constant.

FIG. 3 shows the method to calculate χₗ, the interlevel product (ILP) at level l. This example describes the Interlevel Product Calculation in 1-D (or for a single 2-D subband).

FIG. 3a shows all possible relationships that a sample step edge may have to the nearest sampling point. The dashed horizontal lines indicate the sampling points and represent the locations of the wavelet coefficients shown in FIG. 3b. The 16 positions indicated span the spacing between level 4 wavelet coefficients, and thus represent all possible spatial relationships that a step edge may have with a wavelet coefficient at that level.

FIG. 3b shows the resulting level 4 DT CWT wavelet coefficients corresponding to the 16 shifted edges shown in FIG. 3a. Note that the magnitudes of the level 4 wavelets shift smoothly, as expected, and differences in phase are indeed observed to be linear. However, there are no constant values with which one may detect the presence of the edge in the vicinity.

FIG. 3c shows the corresponding level 3 DT CWT coefficients. Note the similarity to level 4 wavelet behaviour, except that the phase angles rotate twice as fast; and, with the sampling rate doubled, the edge travels through a length that is twice the spacing of a level 3 coefficient.

As the sampling have doubled, there are now, of course, twice as many samples in each vertical column.

In FIG. 3d, the level 4 coefficients shown in FIG. 3b have been upsampled and interpolated to level 3 resolution, and their phase angles doubled. Coefficients are now rotating at the same rate as the level 3 DT CWT wavelet coefficients in FIG. 3c.

Finally, as shown in FIG. 3e, we multiply the level 3 wavelet coefficients in FIG. 3c with the complex conjugate of the corresponding coefficient in FIG. 3d, to form χ₃, the interlevel product at level 3. Note that the ILP phase θ_{Δ} is approximately constant regardless of edge position, and thus provides a truly shift invariant representation of the edge.

Thus, the ILP magnitude is equal to the product of the magnitudes of the contributing DT CWT coefficients at levels l and l+1, and has phase angle equal to θ_{Δ}. This phase is only dependent upon the nature (±step edges vs. ±ridges) of the dominant multiscale feature in the vicinity.

More specifically, by looking at the phase angle (in other words, the direction of the arrows in FIG. 3e) one can determine what type of feature is dominant within the vicinity.

FIG. 4a illustrates this by showing the relationship between the complex phase and the presence of specific features in a one-dimensional ILP.

For instance, a positive step edge generates a large-magnitude ILP coefficient in the vicinity of the edge, oriented at 45° from the positive real axis, in the complex plane. By this mapping, one can see that a negative impulse, for instance, would similarly generate an ILP coefficient oriented at −45°.

This operation can be applied to the six individual subbands of a 2-dimensional DT CWT at each level, to represent the major components for each direction of a 2-D image, as shown in FIG. 4b. Here the features are now aligned with the complex axes, and step edges and impulses have been transformed into 2-D edges and ridges.

These phase relationships correspond very well to simple, geometric edges in artificial images. Natural images, however, possess noisy edges with curves, corners, varying intensities, etc., as well as parallel edges of varying widths. These ‘corruptions’ of straight edges and ridges result in ILP representations whose phases become less alignment-proof at coarse scales—for instance, the phases of the ILP coefficients of the target in FIG. 1 rotate up to ±45 degrees within all of the possible alignment grids. With this factor in mind, we return to the challenge of misalignment-proof multiscale matching.

### 5 ILP TEMPLATE MATCHING RESULTS

As described above, we first transform the N₀×M₀ target T to a Nₗ×Mₗ×6 complex ILP representation χₗ^{(T)}, and the X₀×Y₀ candidate image S to a Xₗ×Yₗ×6 representation χₗ^{(S)}. As Nₗ=N₀/2^{l}, Mₗ=M₀/2^{l}, Xₗ=X₀/2′, and Yₗ=Y₀/2^{l}, this operation greatly reduces the size of the dataset compared in the template match beyond a level 2 decimation.

We then wish to find areas of the candidate image whose ILP phases match the ILP phases of our target at points of strong saliency. Thus, we simply multiply each ILP coefficient in the target χₗ^{(T)} by the complex conjugate of corresponding ILP coefficients from an equivalently sized, decimated, candidate region of S, χₗ^{(S)}(i,j), as below:

r_{(i,j,α,β,d)(l)}=[χₗ^{(S)}(α−i,β−j,d)]*×χₗ^{(T)}(α,β,d)

In our models, (i,j) represents the top left corner of the region of comparison in the search image ILP, (α=1 . . . N_{l,β=1} . . . Mₗ) are the non-negative integers representing each spatial coefficient location, and d=1 . . . 6 is the directional subband. At each coefficient location, the result r_{(i,j,α,β,d)(l)} is a complex value that will be closely aligned with the positive real axis, in the case of a match, or of random phase otherwise. Where the aligned coefficients are of large magnitude (strongly salient) the result will be a large positive real number. Accordingly, a summation of the real components of these r values will give us a correlation measure for the match. We also normalize this sum by the magnitudes of the ILP coefficients, in a manner analogous to the NCC:

$${R}_{( i , j ) ( l )} = [ \frac{{\sum }_{α , β , d} {r}_{( i , j , α , β , d ) ( l )}}{\sqrt{\begin{matrix}( {\sum }_{α , β , d} {\vert {χ}_{l}^{( S )} ( α - i , β - j , d ) \vert}^{2} ) \times \\ ( {\sum }_{α , β , d} {\vert {χ}_{l}^{( T )} ( α , β , d ) \vert}^{2} )\end{matrix}}} ]$$

where |χₗ^{(S)}(α−i,β−j,d)|² and |χₗ^{(T)}(α,β,d)|₂ are calculated as:

|χₗ^{(S)}(α−i,β−j,d)|²=χₗ^{(S)}(α−i,β−j,d)×[χₗ^{(S)}(α−i,β−j,d)]*

|χₗ^{(T)}(α,β,d)|₂=χₗ^{(T)}(α,β,d)×[χₗ^{(T)}(α,β,d)]*

The estimated location of the upper left corner of the target at level l, in ILP coefficients (îₗ,ĵₗ), and in the original pixels (\hat{x},ŷ), is determined by

(îₗ,ĵₗ)=arg max_{(i,j)}R_{(i,j)(l)}

(\hat{x},ŷ)=(îₗ×2^{l},ĵ₁×2^{l})

### 6. INTERLEVEL PRODUCT AVERAGING

Using χ values for 2-D template matching can be improved by calculating the average of χₗ over all possible shift positions of an image; that is, over a neighbourhood of 2^{l}×2^{l} centred on the χₗ coefficients. By observing a χₗ value at a given subband, location, and level, as we shift the input image around the neighbourhood of χₗ, we note that χₗ is not completely invariant; its magnitude certainly changes significantly, and even its phase tends to fluctuate within a π/2 range.

Thus, to make an ILP representation robust, we will want to find the average of the χ coefficients over all possible offsets a target may have in comparison to its coarse-level set of interlevel coefficients. Thus, a χₗ representation will require averaging across a 2×2 collection of offset images, and a χ₂ will require averaging across 4×4 different offset positions. We create each of these offset positions by padding the surroundings of the target with variably sized flat regions at the mean value of the target, then calculate the ILP coefficients, and then average the results. The offsetting procedure is illustrated in FIG. 5 which in practice is the calculation of the interproduct average for a target image. Greyscale values at the edge of the original image (box with arrows) are tapered outwards to reduce edge effects, and the result is translated over the neighbourhood corresponding to the support of a coefficient at the finer level of an interlevel product. These neighbourhoods are illustrated on the left for a level ½, ⅔, ¾, and ⅘ interlevel product. The coefficient values from the results of these shifts are summed and averaged for each subband.

Note that in the image used to calculate DT CWT values and interlevel products, the background extends well beyond the shift neighbourhood shown in FIG. 5, to eliminate the usual wavelet boundary effects.

With this approach, edge effects will cause concerns, between the image border and the flat background; the resulting edges between the image and the background may dominate and corrupt the resulting averaged interlevel products. Accordingly, we taper the edges of the image into the background with a Gaussian blur. The resultant boundary-blurred image is then shifted as described in the previous paragraph to obtain the average at that level pair.

For an N×M image, the result of the above algorithm is an

$$\frac{N \times M}{{4}^{l}} \times 6$$

set of six complex interlevel products, χ̅^{(T)}, of equivalent size and dimension as χ^{(T)}. We always calculate this averaged interlevel product set χ̅ₗ^{(T)} for the N×M target, which is relatively small, and may then use these values instead of χ^{(T)} in the template matching algorithm outlined above. We may also consider averaging the same-level interlevel products χₗ^{(S)} into χ̅ₗ^{(S)} from the search dataset. This activity would be quite computationally intensive, given the presumably large size of the dataset, but could be performed offline prior to the image search.

### 7. GENERALISATIONS

In the section 4 above, a method was described of calculating the ILP between levels three and four. It will be understood, of course, that a similar calculation be done between any two adjacent levels within the tree. Typically, the procedure will be to sample the coarser level wavelet to that of the finer level, by interpolating complex phase and magnitude separately. Then, the complex conjugate of the result is multiplied with the corresponding coefficient of the finer level to create the interlevel product (ILP).

In the preferred embodiment, the result of the multiplication naturally means that the magnitude of the ILP will simply be the product of the magnitudes at each level. However, other possibilities are available. For normalisation purposes, one could take the square root of the product, or alternatively, one could simply define the magnitude of the ILP as being equal to the magnitude of one of the coefficients to be multiplied—either the coarser or the finer level. In the latter case, the magnitude of the other coefficient may simply be ignored. In practice, the ILP magnitude typically varies quite slowly with distance from the feature, and the magnitude itself would not normally be used as a localisation mechanism. Instead localisation can be determined more exactly by proceeding further down within the tree.

Although it is mathematically convenient, it is not absolutely essential for coefficients to be represented in complex form. It would equally be possible, and of course would be mathematically equivalent, to perform calculations on suitable pairs of real numbers instead. To take one specific example, instead of determining the phase of the ILP by multiplying the level 3 wavelet coefficients shown in FIG. 3c with the complex conjugate of the corresponding coefficients in FIG. 3d, one could simply subtract the corresponding (real) phase angles.

Instead of using Complex Wavelet Transforms, one could use suitable Gabor transforms (or indeed other suitable transforms) in phase quadrature.

### 8. CALCULATION OF THE INTER-COEFFICIENT PRODUCT (ICP)

Instead of dealing with coefficients at different levels within the tree, one could, in another embodiment, take adjacent coefficients at the same level. In such a case, the Inter-Coefficient Product (ICP) may be formed simply by multiplying one coefficient by the complex conjugate of an adjacent coefficient at the same level. Since both coefficients will be rotating at the same rate, phase angle doubling is not required. This clearly simplifies the calculations, but the main difference may be that no ‘scale-mixing’ is involved, since both coefficients represent an aspect of the same subband.

All of the alternative calculation methods described above in conjunction with the ILP are of course equally applicable to calculation of the ICP.

1-18. (canceled)

19. A method of identifying within a candidate dataset a target defined by a target dataset, the method comprising:
(a) applying a multi-scale transform to the target dataset and to the candidate dataset to generate respective target and candidate scale-related transform levels, each having a plurality of transform coefficients defining magnitude and phase;
(b) for each of the target and the candidate datasets determining the phase difference between a first coefficient associated with a first location and a second coefficient associated with a second location; the second location being the same as or adjacent to the first location;
(c) at a trial target location within the candidate dataset, comparing the respective target and candidate phase differences to generate a measure of match; and
(d) accepting or rejecting an hypothesis that the target is present at the trial location in dependence upon the measure of match.

20. A method as claimed in claim 19 including determining, at step (b), a target magnitude and a candidate magnitude, and at step (c), further comparing the target and candidate magnitudes to generate the measure of match.

21. A method as claimed in claim 19 in which the multi-scale transform is a complex transform and in which the comparing comprises multiplying each complex representation of the target phase differences by the complex conjugate of each corresponding representation of the candidate phase differences.

22. A method as claimed in claim 21 in which the comparing is repeated for each subband to generate a complex measure of match for each subband, the hypothesis being accepted or rejected in dependence upon the result of a summation of the real values of each of the individual measures of match.

23. A method as claimed in claim 19 in which the target dataset is representative of a target image to be found within a candidate image defined by the candidate dataset.

24. A method as claimed in claim 19 in which the target dataset is representative of a target sample to be found within a candidate one-dimensional data stream, for example an audio stream, defined by the candidate dataset.

25. A method as claimed in claim 19 comprising calculating a measure of match for a plurality of offset locations in addition to the target location, and accepting or rejecting the hypothesis in dependence upon an average of the calculated measures of match.

26. A method of identifying features within a dataset, comprising:
(a) applying a multi-scale transform to the dataset to generate a plurality of scale-related transform levels each having a plurality of transform coefficients defining magnitude and phase;
(b) determining the phase difference between a first coefficient associated with a first location and a second coefficient associated with a second location, the second location being the same as or adjacent to the first location; and the first and second coefficients being on a common level of the transform; and
(c) identifying a feature in dependence upon the phase difference.

27. A method as claimed in claim 26 in which the multi-scale transform is a complex transform.

28. A method as claimed in claim 27 in which the phase difference is determined by multiplying a complex conjugate of the first coefficient by the second coefficient, or vice versa.

29. A method as claimed in claim 19 in which the multi-scale transform is a dual tree Complex Wavelet Transform (CWT).

30. A method as claimed in claim 29 in which the determination of the phase difference is applied to each of the six individual subbands of a two dimensional dual tree Complex Wavelet Transform.

31. A method as claimed in claim 19 in which the multi-scale transform comprises a pair of real-valued transforms in quadrature, for example Gabor functions.
